(19) United States
(12) Patent Application Publication
(10) Pub. No.: US 2007/0276874 A1
(43) Pub. Date: Nov. 29, 2007

(54) Smartcard System

(76) Inventors: Barry Sim Hochfield, Glasgow (GB); Anthony Breslin, East Kilbride (GB)

Correspondence Address: FOLEY AND LARDNER LLP;SUITE 500, 3000 K STREET NW, WASHINGTON, DC, 20007, US

(21) Appl. No.: 10/584,914

(22) PCT Filed: Dec. 23, 2004
(86) PCT No.: PCT/GB04/05434

§ 371 Date: Apr. 3, 2007

(30) Foreign Application Priority Data
Dec. 30, 2003 (GB) 0330179.3

(51) Int. Cl. G06F 17/00

(52) U.S. Cl. 707/200; 707/E17.01

(57) ABSTRACT

A programmable device, for example, a smartcard carries a file system and operating software enabling the on-device file system to interface with at least one off-device file and/or application at a terminal or interface device. The smartcard includes means such as a script engine for running a script command to modify the structure and content of the file system, or the commands to be used for accessing the file system, or any security conditions associated therewith. In the improved smartcard of the invention the script engine is operable to run a plurality of script commands in succession and to use an input/output buffer of the device as an accumulator to allow arithmetic operations. on values held in data files or in the accumulator itself under the control of one or more of said script commands. This allows the system to provide for arithmetic operations, such as ADD, SUBTRACT or COMPARE, or other similar customised operations.

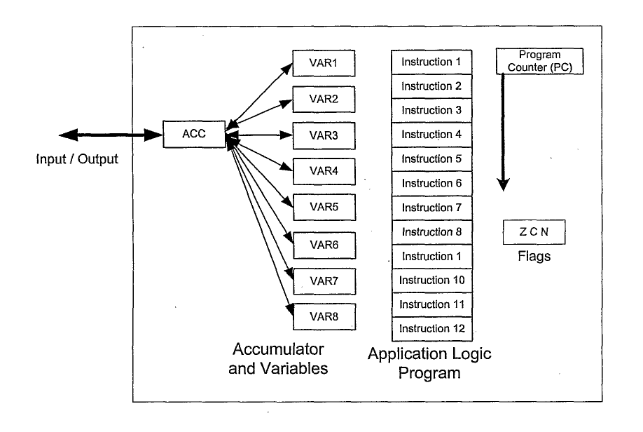

The invention concerns an improvement to the smartcard system described in International Patent Application No WO03/049056 and, in particular, it concerns the possibility of extending the functionality of the scripts and script engine mechanism described in that application and the extension of the range of operations that can be performed.

International Patent Application No WO03/049056 describes a smartcard system in which operating software enables on-card and off-card files and/or applications to interface with one another by means of a file formatted in a web (Internet) standard language for self-describing messages, preferably XML. This file contains at least some of the file system, and commands for accessing the file system, which allow the on-card and off-card files and/or applications to interface. The card includes a script engine for running a script derived from the XML file so as to modify the structure and content of the file system, or the commands to be used for accessing the file system, or any security conditions associated therewith.

In order to extend the existing system described in International Patent Application No WO03/049056, it would be desirable to add other operations over and above the file system commands of Read, Update etc. The additional operations would preferably include arithmetic operations, such as ADD, SUBTRACT or COMPARE, or some other customised operation, on either records within files or simpler Data Objects. However, whilst such functionality is widely available in complex applications, it is necessary, in the context of the system described in WO03/049056 that this functionality be implemented in such a way as to allow the simple script engine carried by the card, in combination with the system's operating system, to carry out required operations. In particular, it is desirable that
the system be able to support a mechanism for returning a result or updating an internal variable based on input data and current application status and variables
the application logic can be updated in the field, that is from a remote location via an electronic, for example, internet-based, distribution system
the existing architecture of the smartcard system of International Patent Application No WO03/049056 be supported
it is possible to impose access conditions to control execution of the application logic

In accordance with the invention, there is provided a programmable device for use in a system of the kind outlined above and the subject of International Patent Application No WO03/049056; the device being characterised in that the means for running the script is operable to run a plurality of script commands in succession and to use an input/output buffer of the device as an accumulator to allow arithmetic operations on values held in data files or in the accumulator itself under the control of one or more of said script commands.

As defined in International Patent Application No WO03/049056, scripts are sequences of Application Protocol Data Units (‘APDUs’) according to ISO 7816-4, pertaining in the most part to file system manipulation.

Values may, preferably, be read from, and written to, data files or the accumulator using the Read Record and Update Record commands, respectively, of the operating software

We have thus further appreciated that the machine operating codes are able to perform comparisons and arithmetic operations between registers. The standard READ and UPDATE commands could be used to perform the basic operations of getting data in and out of registers (records). One way of doing this would be having a fixed size register (record) as it makes the comparisons and arithmetic easier, requiring much less development time. Thus, by effectively treating each record as a register, and using existing machine code operations it is possible to achieve additional functionality of the kind proposed.

Preferably, the means for running the script is capable of carrying out a comparison of values and to branch to a predetermined one of the plurality of script commands in dependence on the outcome of the comparison.

Thus, if the script engine itself is enhanced to include CONDITIONAL statements (IF . . . THEN GO TO APDU X) then the functionality can be increased to allow applications such as electronic purse operations to be configured as a script which can be run by the on-card script engine proposed in International Patent Application No WO03/049056. In such an enhanced script engine, the results of a COMPARE command can be used to direct the sequence of ADPUs to be executed next. This in effect gives the script programme flow capabilities enabling the construction of scripts to perform macro-like operations such as are required to have the card make complex decisions after, for example, examining a history of transactions.

The key benefit of adding this programme flow capability up at the script level is that all the issues relating to data isolation, low level communication etc are taken care of by the lower layers of the smartcard system. The card's operating system and, so, the business logic of a particular application can be specified and captured at a very high level, with user friendly interfaces, such as flow charts, which can be built and translated “off the card”, into the script to run on the card. XML formatting would probably be used as the ‘pseudo code’ intermediate stage as an enhancement to the XML file system model already described in International Patent Application No WO03/049056 and so acts as the business logic input to the terminal framework of that system. Also the Configurator tool described in International Patent Application No WO03/049056 can be extended to include such flow-charting and ladder sequence diagrams as the requirements entry point.

In addition, the sequence of commands to be issued by the terminal or interface device would, in the improved system, include script selection and execution to make up a complete Business Application such as a payment request on a credit card.

The benefit is to enable the simultaneous development of terminal and card applications by going straight from application high level functional requirements (human generated diagrams) to running code including more complex business logic running on either or both platforms.

To summarise, the system described in International Patent Application No WO03/049056 does not automate the generation of Business Logic. The enhancement to the script mechanisms of that system outlined above and described in greater detail below enables the automated generation of business logic code running on the card, and can be extended to run on the terminal also. This leaves only the user interface and host communications aspects of terminal design to be developed by traditional methods, which are themselves already highly efficient.

An embodiment of the invention will now be described in detail, by way of example, by reference to the accompanying drawing which illustrates the high level architecture of such a system.

In a system having one or more working variables and several system variables, it is desirable to provide a set of basic control and logic functions, as follows:

| Function | Requirements |
|---|---|
| Load | Load from system variable to working variable |
| | Return system variable. |
| | Return working variable |
| Store | Store working variable to system variable. |
| | Store input data to system variable. |
| | Store input data to working variable. |
| And | Logical AND of system variable with working variable |
| | This function may effect the following flags |
| | EQUAL |
| Or | Logical OR of system variable with working variable |
| | This function may effect the following flags |
| | EQUAL |
| XOR | Logical XOR of system variable with working variable |
| | This function may effect the following flags |
| | EQUAL |
| Compare | Compare working variable to system variable |
| | This function may effect the following flags |
| | EQUAL |
| | GREATER THAN |
| Add | Add system variable to working variable |
| | This function may effect the following flags |
| | NEGATIVE |
| | ZERO |
| Subtract | Subtract system variable from working variable. |
| | This function may effect the following flags |
| | NEGATIVE |
| | ZERO |
| Branch | Conditional branching based on flags |
| | Branch always |
| | Branch if equal |
| | Branch if not equal |
| | Branch if higher |
| | Branch if lower |
| | Branch if positive |
| | Branch if negative |
| Exit | Return data or error |

These commands can be supported on a simple command processor or script engine with a single working accumulator and multiple system variables stored in RAM. The system would also require a program counter and a set of status flags: ZERO (EQUAL), CARRY (GREATER THAN) and NEGATIVE.

An overview of the high level architecture required to implement the commands listed above is shown in the drawing. All operations are performed on the accumulator and it is possible to move the content of one variable to other variables via the accumulator. The program counter steps through each of the instructions in turn; if the instruction is a branch instruction the counter will move on to the appropriate instruction as defined by the branch test.

Application logic can be implemented on the existing script processing mechanisms and data structures that supported by the system of International Patent Application No WO03/049056. Within this system, system variables can be implanted with records, and an accumulator implemented using the input/output (‘IO’) buffer. A mechanism already exists within the system for loading data from variables and storing data to variables, in the form of the system's Read Record and Update Record commands. The system's security manager allows creation of a security environment to control access to the variables offering support for secure messaging to input and output data.

As the script manager does not check that the script contains data even though the length of the expected command data in an APDU, ‘Lc’, is specified in the APDU, the system will allow, for example, an Update Record command script with a Lc value, but no data. This command will use the data in the buffer from the previous command. This mechanism can be used by the commands to allow operations on either script data (absolute value) or the existing data from the last script result.

The script manager of the system of International Patent Application No WO03/049056 already steps through single commands. The additional application logic functionality will allow branching within the list of scripts (instructions). The script manager already provides support for checking the integrity and authorisation of the script contents. It also supports downloading of encrypted application logic programs.

A smartcard application of the kind envisaged can use a one or more record file for its application data. Within the files it can have up to 254 records. By using short file identifiers (‘SFIs’) as defined in ISO 7816 File System, the command to read, update or any other record command can be contained in a single command script specifying the file, record and operation. To simplify processing all records should be a constant length. Using 4-byte records, a system which can support signed integers in the range −32768 to +32767 can be provided.

As mentioned above, the system's Read Record and Update Record commands can be used to implement Load and Store operations. Additional commands are required to support the AND, OR and XOR logical operations. These are in some degree supported already within the smartcard system of International Patent Application No WO03/049056. For example, the Write Record command will perform an AND or OR logical update, which may affect the ZERO (‘Z’) flag.

Add and Subtract would be implemented as new commands which would add or subtract the value in a record from the value held within the command data or from the value in the accumulator. These commands may update the Z or NEGATIVE (‘N’) flags.

The Compare command would have to be implemented as a new command which would simply compare the value in the command or in the accumulator with the value in the specified record. It may update the EQUAL (‘Z’) or CARRY (‘C’) flags.

The Branch command is implemented as a command which would update the script pointer based on the state of the flags. The script pointer would be modified relative to its position (relative branch) by a fixed number of scripts (positive or negative) as specified in the Branch command.

The Exit command is required to exit from the script with a result or error. The exit data would contain the error code returned in the SW1 SW2 parameters of the existing system.

A record file can under the existing system described in International Patent Application No WO03/049056 have its access conditions set to allow updating of the record data. The update may have no access conditions or, alternatively, may require previous authentication or secure messaging of the input data. As a record file could be used to return data with it access conditions set to, secure messaging (‘SM’). If the last script reads this record file, the Security Environment will sign the data, certifying the response.

The scripts will be signed and optionally encrypted by the card issuer/scheme owner before they are stored on the terminal. As the script manager will only run a verified script neither the terminal nor anyone else can download and run scripts on the card or modify existing scripts.

The following example illustrates the capabilities of the proposed logic in the context of an electronic purse scheme.

### EXAMPLE

An electronic purse consists of 4 purses. The scheme requires the following operations:
Read Balance
   (Balance is Certified)
Decrement Balance
   (Configurable auto transfer of funds from one purse to another if insufficient funds.
   Error if not enough funds in purse and transfer purse.)
Increment Balance
   (Online Load Only)
Transfer Balance
   (Error if not enough funds.
   Error if purse ceiling reached.)

A record file will be created that has for each purse
A record with the balance

A record file will be created with the following records
A record to specify the amount to be decremented or transferred

The system scripts will provide for the following operations
Read Balance
(The balance read will be supported by a normal Read Record Command. The SE for the file will support SM for reads to certify the value.)
Decrement Balance
(A script will be created that will be downloaded and run by the terminal to decrement the specified purse by a specified amount.)
Increment Balance
(A normal Update Record Command will support the balance increment. The SE for the file will mandate SM for updates to allow only on-line loads. The on-line update will also be used to update the ceilings and thresholds.)
Transfer Balance
A script will be created that will be downloaded and run by the terminal to transfer funds between purses. The purses and amount are input.

The low level coding for putting these steps into operation could be:

Decrement Balance

| | |
|---|---|
| 1. | Get purse number and current purse value to be processed |
| 2. | Get amount to be decremented |
| 3. | If current value − dec amount < 0 // support overdraft |

| | |
|---|---|
| a. | If auto funds transfer supported |

| | |
|---|---|
| i. | If ((transfer purse balance + current val) |

− dec amount) < 0. // Test if transfer
purse + current balance does not have
enough funds

1. return error

| b. | transfer value = amount − current val // how |
|---|---|
| | much do we have to transfer |
| c. | transfer purse value = transfer purse value − |
| | transfer value |
| d. | current val = current val + transfer value |

| | |
|---|---|
| 4. | current val = current val − dec amount |
| 5. | read certified current amount |

Transfer Funds

| | |
|---|---|
| 1. | Get purse 1 (transfer from) number and value |
| 2. | Get purse 2 (transfer to) number and value |
| 3. | Get transfer amount |
| 4. | If purse 1 val − amount < 0 |

| | |
|---|---|
| a. | Return error |

| 5. | If purse 2 val + amount > upper ceiling // test for |
|---|---|
| | overflow |

| | |
|---|---|
| a. | Return error |

| | |
|---|---|
| 6. | purse 1 value = purse 1 value − amount |
| 7. | purse 2 value = purse 2 value + amount |
| 8. | read certified purse 2 value |

A request to decrement the balance in a purse would be handled as follows:

Prior to running the script proper, the system would need to acquire the amount to be decremented from the user's purse from the merchant or supplier. The access conditions of the files are used authorise the loading and running of the script.

| N | Command | Parameters | Notes |
|---|---|---|---|
| | Update Rec | Input params rec 1, | Specify the amount to decrement |
| | | amount | |

Then the system runs the script commands themselves, as follows:

| N | Command | Parameters | Notes |
|---|---|---|---|
| 01 | Read Rec | Purse balance record | Read the current |
| | | | balance into the |
| | | | buffer |
| 02 | Update Rec | Temp record 1, Acc | Store the value |
| | | | in a temp variable 1 |
| 03 | Read Rec | Input params rec 1 | |
| 04 | Sub Rec | Temp record 1, Acc | Subtract the amount to |
| | | | be decremented |
| 05 | Branch if +ve | 07 | Branch to decrement if |
| | | | sufficient funds, +7 |
| | | | scripts |
| 06 | Read Rec | Transfer Rec, | Read the transfer |
| | | | balance |
| 07 | Add Rec | Temp record 1 | Add the transfer |
| | | | balance to the amount |
| | | | deficient |
| 08 | Branch if +ve | 02 | Continue efficient |
| | | | funds |
| 09 | Exit | NOT_ENOUGH_FUNDS | Return error |
| 0A | Read Rec | Temp record 1 | Read the remaining |
| | | | transfer balance |
| 0B | Update Rec | Purse transfer record, | Store new remaining |
| | | Acc | transfer balance |
| 0C | Update Rec | Temp record 1, 0 | Clear the new |
| | | | balance |
| 0D | Read Rec | Temp record 1 | Updated balance |
| 0E | Update Rec | Purse balance record, | Store new balance |
| | | Acc | |
| 0F | Read Rec | Purse balance record | Return the new |
| | | | balance |

This script would require 15 script commands and would be around 100 bytes before encrypting and signing.

Where a balance is to be transferred, the sequence of script commands is as follows. Again, the access conditions of the files are used to authorise the loading and running of the script. As a preliminary step the system would need to acquire the amount to be transferred.

| N | Command | Params | Notes |
|---|---|---|---|
| | Update Rec | Input params rec 1, | Specify the amount to transfer |
| | | amount | |

Purse1=Transfer FROM purse. Purse2=Transfer TO purse.

The script commands would then be:

| N | Command | Params | Notes |
|---|---|---|---|
| 01 | Read Rec | Purse1 Record | Read the balance from |
| | | | the transfer from purse |
| 02 | Update Rec | Temp record 1, Acc | Store the value in a |
| | | | temp variable 1 |
| 03 | Read Rec | Input params rec 1 | Get the amount to |
| | | | transfer |
| 04 | Sub | Temp record 1, Acc | Subtract amount from |
| | | | balance |
| 05 | Branch +ve | 02 | Continue is sufficient |
| | | | balance to transfer |
| 06 | Exit | NOT_ENOUGH_FUNDS | Return error |
| 07 | Read Rec | Purse2 Record | Read the balance from |
| | | | the transfer to purse |
| 08 | Update Rec | Temp record 2, Acc | Store the value in a |
| | | | temp variable 2 |
| 09 | Read Rec | Input params rec 1 | Get the amount to |
| | | | transfer |
| 0A | Add | Temp record 2, Acc | Add the transfer amount |
| | | | to Purse2 |
| 0B | Branch +ve | 02 | Continue if no overflow |
| 0C | Exit | OVER_FLOW | Return error |
| 0D | Read Rec | Temp record 1 | Get new Purse1 balance |
| 0E | Update Rec | Purse1 Record, Acc | Store |
| 0F | Read Rec | Temp record 2 | Get new Purse2 balance |
| 10 | Update Rec | Purse2 Record, Acc | Store |
| 11 | Read Rec | Purse2 Record | Return new Purse2 |
| | | | balance |

Thus, it will be appreciated from the description above that the improved system described above will allow application logic controlling code to be downloaded and run on a smartcard or other programmable device utilised in the system of International Patent Application No WO03/049056. It offers a simple set of logical and arithmetical processing and control functionality and is independent of the platform used.

1-8. (canceled)

9. A programmable device carrying a file system and operating software enabling the on-device file system to interface with at least one off-device file and/or application; the structure and content of the on-device file system, the commands to be used for accessing the file system and any security conditions associated therewith being defined by at least one file formatted in a web (Internet) standard language for self-describing messages; the device including means for running a script command to modify the structure and content of the file system, or the commands to be used for accessing the file system, or any security conditions associated therewith, the device being characterised in that the means for running the script is operable to run a plurality of script commands in succession and to use an input/output buffer of the device as an accumulator to allow arithmetic operations on values held in data files or in the accumulator itself under the control of one or more of said script commands.

10. A device according to claim 9 wherein the means for running the script is capable of carrying out a comparison of values and to branch to a predetermined one of the plurality of script commands in dependence on the outcome of the comparison.

11. A device according to claim 9 wherein values are read from, and written to, data files or the accumulator using the Read Record and Update Record commands of the operating software, respectively.

12. A programmable device according to claim 9 in which the web (internet) standard language for self-describing messages is eXtensible Markup Language (‘XML’) and the at least one file is an XML document.

13. A device according to claim 9 wherein the means for running the script is capable of carrying out an addition or subtraction operations between data in an accumulator and data in a register.

14. A device according to claim 9 wherein the means for running the script is capable of carrying out logic AND, OR and XOR operations between data in an accumulator and data in a register.

15. A device according to claim 9 wherein one or more flags can be set and cleared based on the result of the script command executed, such that the flow of the next script or scripts to execute can be logically controlled.
